(19) United States
(12) Patent Application Publication
(10) Pub. No.: US 2001/0038337 A1
(43) Pub. Date: Nov. 8, 2001

(54) Smoke detector with time out capability

(76) Inventors: James Wickstead, Cedar Knolls, NJ (US); Curtis L. Stillwell, Hopatcong, NJ (US)

Correspondence Address: Louis Weinstein, Esq., Volpe and Koenig, P.C., One Penn Center, Suite 400, 1617 John F. Kennedy Boulevard, Philadelphia, PA, 19103, US

(21) Appl. No.: 09/848,875

(22) Filed: May 4, 2001

Related U.S. Application Data
(60) Provisional application No. 60/202,204, filed on May 5, 2000.

(51) Int. Cl. G08B 17/10

(52) U.S. Cl. 340/628; 340/309.15; 340/506; 340/527

(57) ABSTRACT

A smoke detector which may be hard wired or battery operated and having circuitry for providing an audio/visual alarm upon detecting smoke. A radio frequency, infrared or other form of detector detects a signal from a remote RF, infrared or other compatible transmitter. The activation of the transmitter operating button transmits an appropriate signal to the compatible receiver which initiates a timer for disabling the audio/visual alarm signal generated by the smoke detector for a predetermined time interval which may be adjustable, if desired. Recognition that the circuitry has detected the transmitted signal is by way of flashing an LED or other illuminating device thereby providing an indication that the time-out request signal from the transmitter has been received and acknowledged. The smoke detector automatically turns back on when the time-out period has elapsed. A coding scheme is provided to prevent the smoke detector from being turned on by another remote transmitter or by IR possibly generated by a fire occurring within the visual viewing range of the IR receiver.

This application claims priority to U.S. Provisional Patent Application No. 60/202,204, filed May 5, 2000.

### BACKGROUND OF THE INVENTION

The present invention relates to smoke detectors and more particularly, to a novel time-out capability for a smoke detector activated by a compact, remote transmitter.

Smoke detectors are well known in the art and provide a most important audio/visual warning to alert personnel of the potential danger of smoke which has been detected and are in widespread use throughout all types of areas and establishments, including military, industrial, institutional and home use.

Nevertheless, a major irritation with smoke detection devices installed in locations where non-threatening smoke or other detectable residuals exist and are commonly encountered, such as kitchens, wood working shops, garages and the like, can create a nuisance of having to stop and reset the smoke detectors or in some cases, to cover them over or electronically disarm them by removing the battery in order to avoid the generation of an audio/visual alarm which is caused by smoke created under a controlled condition, such as, for example, a kitchen in which certain foods stuffs are being deliberately smoked.

In many instances, the smoke detector units are mounted high on a wall or directly onto a ceiling rendering it very inconvenient to obtain simple access to the smoke detector. For example, it is impractical and potentially dangerous to turn off the smoke detector by removing the battery or operating a manually operated on/off switch. Due to the manner in which smoke detectors are mounted and also due to their shape, it is most inconvenient to drape or attempt to drape a cloth or towel over the smoke detector during the period in which the food stuff smoking operation is being performed, for example. All of these activities in addition, necessitate the use of a ladder or step stool in order to reach the smoke detector making it most inconvenient to temporarily disable the smoke detector.

More importantly, there is an inherent danger that the person or persons who turn off or disarm the smoke detector may forget to reactivate it, thus, rendering it useless in the event that smoke generated due to an uncontrolled situation, such as, an actual fire or other smoke generating event.

### SUMMARY

The present invention provides a smoke detector with time-out capability that overcomes the disadvantages of the prior art and is characterized by comprising a timing circuit, which is activated by a sensor having a capability of detecting a transmission of a wireless signal from a remote transmitter. The detected signal activates the timing circuit, which disables the smoke detector for a predetermined time interval (for example, 15 minutes) and further, upon receipt of the signal requesting disablement of the smoke detector, generates an audio/visual signal for a predetermined, short time interval, which serves as an acknowledgment that the request signal has been received.

The timing circuit disables the battery coupled to the smoke detector circuit. When the timing interval has elapsed, the smoke detector circuit is automatically reactivated.

The remote wireless transmitter is a small, compact device which includes a portable battery and a transmitter element, such as, an infrared lamp, or other wireless signal generator. The receiver/sensor in the smoke detector, which is compatible with the transmitter, has a capability of detecting that particular signal so as not to be accidentally activated by another remote transmitter or other device. The remote transmitter may be provided with a magnet to allow mounting on a refrigerator door, for example, and may also be provided with a lanyard for hanging upon a hook to make the transmitter easily accessible.

Alternatively, a holder may be mounted on a support surface for holding the remote transmitter when not in use.

The battery size and power required for the transmitter is quite small since the distance over which the signal is transmitted is no more than 5 or 10 feet, for example, the distinct advantage of the remote transmitter being the ability to temporarily disable the smoke detector which is otherwise out of normal reach in the absence of a ladder or stepstool.

### BRIEF DESCRIPTION OF THE DRAWINGS

It is therefore one object of the present invention to provide a smoke detector having a capability of providing a controlled time-out period and to automatically reset the smoke detector upon the termination of the time-out period to assure continued proper operation thereof.

Another object of the present invention is to provide a smoke detector having a novel time-out capability and which is activated by a small, compact, remote transmitter enabling the time-out capability to be initiated without the necessity for physically manipulating or making contact with the smoke detector which is typically mounted in a location which is normally out of the reach of a person and would otherwise require the need for a ladder or step stool.

The above as well as other objects of the present invention will become apparent when reading the accompanying description and drawings in which:

FIG. 1 is a perspective view of a smoke detector device embodying the principles of the present invention; and

FIG. 2 shows an alarm delay switch incorporated in the smoke detector device shown in FIG. 1; and

FIG. 3 is a schematic diagram of the remote transmitter of FIG. 1.

### DETAILED DESCRIPTION OF THE PREFERRED EMBODIMENTS

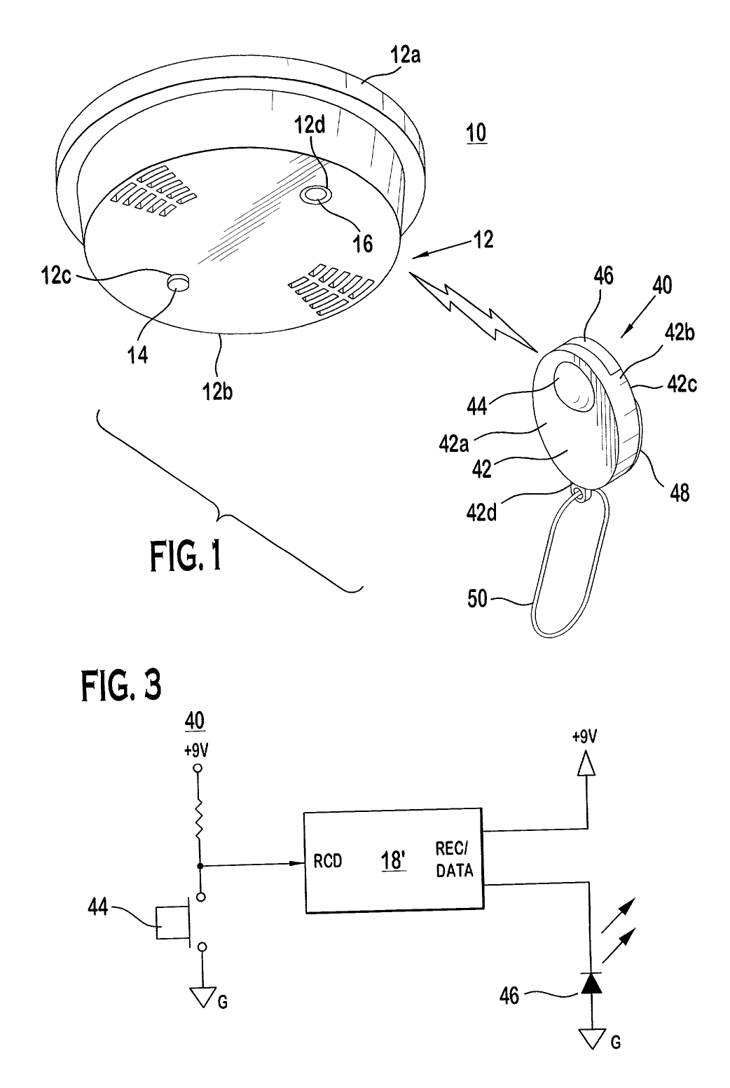

FIG. 1 shows a smoke detector 10 embodying the principles of the present invention and usable with a small, compact remote transmitter 40.

The orientation of the smoke detector 10 is that in which the smoke detector would be mounted to a ceiling or other overhead surface, the mounting surface 12a of the housing 12 being arranged against the overhead surface (i.e., ceiling or roof). Downwardly facing surface 12b is provided with first and second openings 12c, 12d, respectively, provided for an LED indicator 14 and a receiving sensor 16. Although the housing 12 is shown as having a generally cylindrical shape, the shape of the smoke detector housing is non-critical and lends no novelty to the present invention other than to provide a surface which is other than the surface of the smoke detector housing which engages a mounting surface of a wall, ceiling or other mounting surface and having openings for exposing the LED 14 and receiving sensor 16.

The remote transmitter 40 is a small compact device having a housing 42 provided with an opening 42a to expose a depressible operating button 44. The housing 42 has a shape, which preferably, can be easily held within the fingers and palm of one hand enabling the thumb or other finger to operate the depressible button 44. A side surface 42b is provided with an opening for exposing the light, sound or electromagnetic signal produced by the generating device 46. The surface 42c opposite that of the surface having opening 42a, may be provided with a permanent magnet member 48, which may be of a rubberized material having magnetized particles admixed therewith, to enable the transmitter to be releaseably secured to a refrigerator door, for example. In addition, the housing 42 is preferably molded to provide an integral eyelet 42d for receiving a lanyard 50, which may be placed over a hook or other suitable projection, which supports the transmitter when not in use and which is preferably, located in close proximity to the smoke detector device 10, such as, for example, a peg provided on a peg board which is mounted upon a wall in close proximity to the smoke detector which may, for example, be mounted upon a ceiling at some location within a room or region which includes the aforesaid wall upon which the mounting peg board is arranged. Obviously, any other type of support or holder may be provided, the type of mounting or support being secondary to the transmission capability of the transmitter.

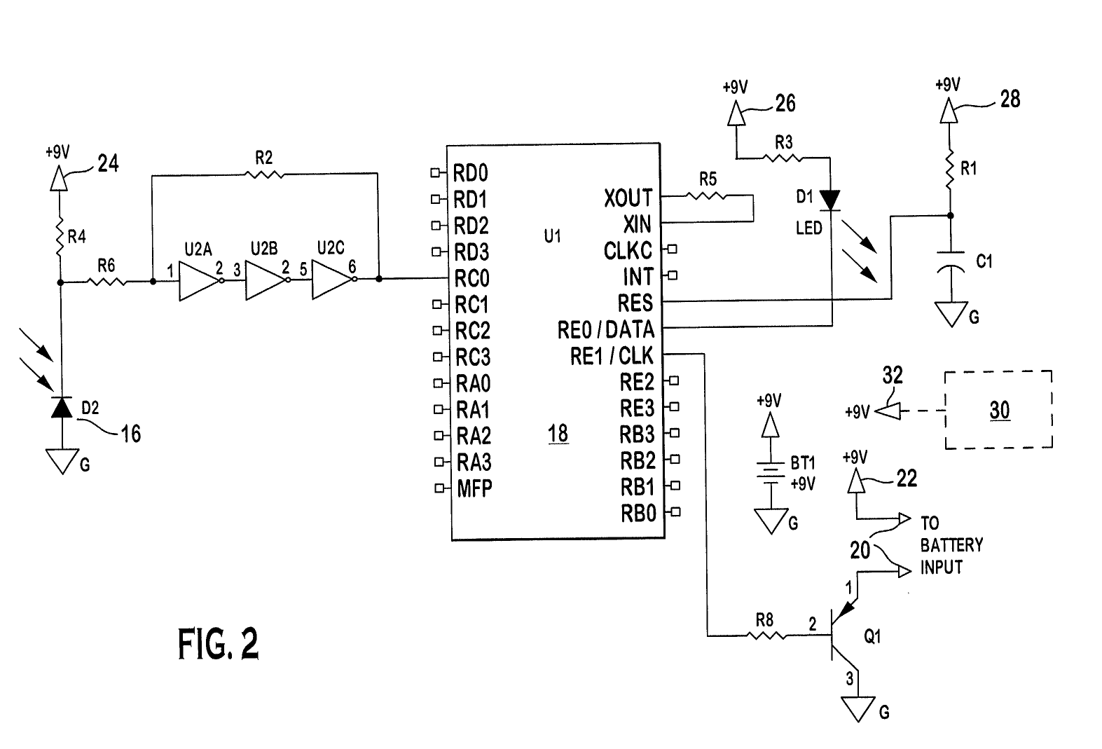

FIG. 2 shows a simplified schematic of the time-out device of the present invention. An integrated circuit chip (IC), such as a W74110 having the capability of providing a time interval of a given length, is employed.

The sensor 16, in one preferred embodiment, is a diode which is sensitive to IR (infrared) signals. The time-out circuitry, shown in FIG. 2, is powered by a 9-volt battery BT1. Normally, in the absence of an IR signal from transmitter 40, battery BT1 is coupled across terminals 20. The integrated circuit 18 is preferably a microprocessor. In one preferred embodiment, the microprocessor may, for example, be a model W74110 manufactured by Windbond Company of China. However, any other microprocessor having similar capabilities may be utilized. Also, the present invention may be employed with smoke detectors which are hard-wired to run on normal household electric power (110 VAC).

In the absence of a time-out signal request, MPU 18 has its output RE1/CLK coupled to the base of transistor Q1 through resistor P8. The signal at the base of Q1 maintains Q1 conductive completing a conductive path between ground G, transistor Q1, and the battery BT1 coupled across terminals 20. The output terminal 22 is coupled to each of the terminals 24, 26 and 28, as well as the +9V terminal 32 of the smoke detector 30, shown in dotted-fashion. Thus, the smoke detector is normally on.

The smoke detector may be any suitable smoke detector which is typically powered by a standard 9-volt or other small, light-weight battery. The smoke detector may be of a smoke or particle detector type, or other type having similar capabilities.

The RF detecting circuit comprised of diode 16 is coupled between +9-volt terminal 24 and ground G through resistor R4. The common terminal therebetween is coupled to the input of a digital-type amplifier circuit comprised of invertors U2A, U2B and U2C, which are preferably of the type 74C04. The output of U2C is coupled through resistor R2 to the input of U2A.

The output of U2C is coupled to the input RC0 of MPU 18. The amplifier circuit amplifies the signal detected by IR detector 16. MPU 18 is coded so as to identify a particular IR signal and to differentiate this IR signal from a signal which may be generated by another transmitter. As one simple example, MPU 18 may be programmed to recognize two short pulses, a pause of a predetermined interval followed by three short pulses. Obviously, any succession of short pulses, pauses and subsequent pulses (either shorter or longer) may be programmed so as to differentiate the coded activating pulses of each time-out smoke detector from every other detector, there being a wide variety of permutations and combinations of pulses and pauses which may be programmed into the MPU 18 to provide an extremely large number of coded arrangements to substantially differentiate each time-out smoke detector from all of the others.

Upon recognition of the correct series of pulses and pauses detected by the MPU 18, the MPU activates the LED 14 by flashing the LED on and off for several seconds to provide a positive indication to the operator utilizing transmitter 40 that the request for a time-out period has been received and acknowledged. The LED should then either remain illuminated or continue to flash on and off until the time-out period has elapsed, to enable an observer to determine if the unit is still on and operating properly. Substantially, simultaneously therewith, MPU 18 applies a signal level to the base of Q1 rendering it non-conductive and preventing operation of the smoke detector 30. In addition, the opening of the battery circuit deactivates the terminal 24 preventing a further transmitter signal from being received and acknowledged. If desired, the LED may be replaced by an audio signal acknowledging receipt of a proper time-out request signal or may be a combination audio/visual acknowledgment signal. Preferably, the audio acknowledgment signal is different from the audio alarm generated by the smoke detector when smoke is detected.

The MPU 18 is programmed to provide a given time interval by selection of a resistor R5 whose resistance value applied across terminals XOUT and XIN controls the length of the time-out interval. An internal clock and divider circuitry accumulates elapsed time and when the desired time interval is reached, the output RE1/CLK of MPU 18 changes signal level to turn on transistor Q1 and thereby reactivate smoke detector 30 and the RF input circuit containing the IR sensitive diode D2.

As an alternative to deactivating the smoke detector, the transistor Q1 may be wired across the audio/visual alarm portion of the smoke detector to disable the audio/visual alarm without affecting operation of the smoke detector so that, when the timing interval of the time-out circuit has been reached, the smoke detector is maintained energized, the only difference being that the short-circuit across the audio/visual alarm portion of the smoke detector circuit 30 is removed and enables the smoke detector to immediately regenerate an audio/visual alarm without the need for any warm-up.

A power on reset circuit comprised of resistor R1 and capacitor C1 coupled between 9-volts and ground G provides a power on reset capability, the common terminal between R1 and C1 being coupled to the reset input RES of MPU 18.

FIG. 3 shows a simplified schematic diagram of the IR transmitter 40 comprised of push button 44, MPU 18′, which may substantially be identical in design and function to the MPU 18, and a IR transmitter 46. By depressing push button 44, an electrical circuit is completed between the 9-volt battery source provided within the transmitter 40 and ground G applying a signal to the input RC0 of MPU 18′. The MPU 18′ is programmed to generate a specific pattern of long and/or short pulses and pauses, which pattern is identical to the pattern of long and/or short pulses and pauses programmed into MPU 18. This pulse/pause pattern is coupled to IR transmitter 46. The IR transmitter, preferably, is held in such a manner as to generally orient the IR diode 46 in the direction of the IR receiver diode 16. When the pattern of pulses and pauses is detected, MPU 18, within the time-out smoke detector 10, operates in the manner described hereinabove to disable transistor Q1 for the time-out interval for which the MPU 18 has been programmed.

Although the preferred embodiment herein has been described as utilizing an IR transmitter and cooperating receiver, any other form of transmission/reception elements may be utilized, such as, an RF transmitter/RF receiver, sonic transmitter/sonic receiver or the like, which devices are likewise appropriately coded to either provide pulses and pauses or in the case of an RF signal, to provide a electromagnetic waveform of a given frequency, for example. Alternatively, the RF signal may be a carrier signal, which is amplitude or frequency modulated or otherwise pulsed. Other signals may be employed, such as, an LED and filter functioning as a transmitter, which transmits light of a particular color wavelength with the receiver being provided with a diode and suitable filter which recognizes the color frequency of light transmitted by the transmitter.

Obviously, any other type of transmitter /receiver may be utilized, the less expensive the device while still providing the desired security being preferred in order to provide a smoke or fire alarm detector having a time-out capability of good quality and yet, low cost.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein described.

What is claimed is:

1. A time-out capability for a smoke detector comprising a sensor for sensing a time-out request signal derived from a remote transmitter;
an acknowledgment device;
an operating circuit for operating said acknowledgment device to acknowledge receipt of the time-out request signal and for disabling at least an audio/visual alarm circuit of a smoke detector/fire alarm to disable the audio/visual alarm circuit for a predetermined time interval, said operating circuit automatically enabling the audio/visual alarm circuit upon termination of the time-out interval.

2. The apparatus of claim 1 wherein said detector detects IR signals.

3. The apparatus of claim 1 wherein said detector detects RF signals.

4. The apparatus of claim 1 wherein said detector detects sonic signals.

5. The apparatus of claim 1 wherein the circuit further comprises preprogrammed circuitry for decoding only a given pattern of pulses and pauses so as to uniquely identify the smoke detector time-out circuit.

6. The apparatus of claim 1 further comprising a transmitter comprised of a transmitter and a circuit activated by an operating push button for causing the transmitter to transmit a predetermined combination of pauses and pulses upon operation of the manual push button.

7. The apparatus of claim 1 wherein said acknowledgment device is an LED or other illuminating component

8. The apparatus of claim 1 wherein said acknowledgment device generates an audio signal.

9. The apparatus of claim 1 wherein said acknowledgment device generates an audio/visual signal.

10. The apparatus of claim 6 wherein the transmitter is an IR transmitter.

11. The apparatus of claim 6 wherein the transmitter is an RF transmitter.

12. The apparatus of claim 6 wherein the transmitter is an sonic transmitter.

13. The apparatus of claim 1 wherein the acknowledgment device remains illuminated during the time-out interval.

14. The apparatus of claim 1 wherein the acknowledgment device flashes on and off during the time-out interval.
